(19) United States
(12) Patent Application Publication
(10) Pub. No.: US 2017/0269687 A1
(43) Pub. Date: Sep. 21, 2017

(54) METHODS AND APPARATUS TO PROVIDE HAPTIC FEEDBACK FOR COMPUTING DEVICES

(71) Applicant: GOOGLE INC., Mountain View, CA (US)

(72) Inventors: Shahid HUSSAIN, San Francisco, CA (US); Katie Leah ROBERTS-HOFFMAN, San Jose, CA (US)

(21) Appl. No.: 15/072,900

(22) Filed: Mar. 17, 2016

(51) Int. Cl. G06F 3/01; G06F 3/0482; G06F 3/0485; G06F 3/041

(52) U.S. Cl. CPC G06F 3/016; G06F 3/0416; G06F 3/0482; G06F 3/0485

(57) ABSTRACT

Example methods and apparatus to provide haptic feedback for computing devices are disclosed. A disclosed example method includes presenting a menu having a plurality of menu items, receiving data representative of navigation of the menu items using a touch input device, processing the data to determine when menu items is navigated, and as the menu items are navigated, providing haptic feedbacks via the touch input device.

### FIELD OF THE DISCLOSURE

This disclosure relates generally to computing devices, and, more particularly, to methods and apparatus to provide haptic feedback for computing devices.

### BACKGROUND

Computing devices have one or more user input devices that allow a user to provide inputs to the computing device. Example user input devices include, but are not limited to, keyboards, mice, trackpads, touchpads, touch displays, microphones, touch screens, etc. Example computing devices include, but are not limited to, portable computers, laptop computers, mobile devices (e.g., smartphones, media players, game players, mobile phones, etc.), desktop computers, etc.

### SUMMARY

A disclosed example method includes presenting a menu having a plurality of menu items, receiving data representative of navigation of the menu items using a touch input device, processing the data to determine when menu items is navigated, and as the menu items are navigated, providing haptic feedbacks via the touch input device.

A disclosed example computing device includes an output device to present a plurality of items, a touch input device configured to enable a person to scroll through the plurality of items, a tactile feedback device associated with the touch input device, and a processor programmed to, sense scrolling of the plurality of items via the touch input device, and as the items are scrolled by, providing tactile feedbacks via the tactile feedback device.

A disclosed example tangible non-transitory article of manufacture stores machine-readable instructions that, when executed, cause a machine to at least present a menu having a plurality of menu items, receive a signal representative of traversal through the menu items using a touch input device, processing the signal to determine when menu items are traversed, and as the menu items are traversed, providing haptic feedbacks via the touch input device.

### BRIEF DESCRIPTION OF THE DRAWINGS

FIG. 1 is schematic illustration of an example computing device (e.g., a laptop computer) having a screen, a keyboard and a trackpad.

FIG. 2 is schematic illustration of another example mobile computing device (e.g., a mobile phone) having a touch screen.

FIG. 3 is a schematic illustration of an example computing device configured to provide haptic feedback in accordance with the teachings of this disclosure.

FIG. 4A is a top view of an example touch input device in accordance with the teachings of this disclosure.

FIG. 4B is a side view of a portion of the example touch input device of FIG. 4A.

FIG. 5 illustrates example haptic feedbacks in accordance with the teachings of this disclosure.

FIG. 6 illustrates other example haptic feedbacks in accordance with the teachings of this disclosure.

FIG. 7 illustrates still other example haptic feedbacks in accordance with the teachings of this disclosure.

FIG. 8 is a schematic illustration of another example computing device configured to provide haptic feedback in accordance with the teachings of this disclosure.

FIG. 9 is a flowchart illustrating an example method that may, for example, be implemented using machine-readable instructions executed by one or more processors to perform the methods and apparatus to provide haptic feedback disclosed herein.

FIG. 10 is a block schematic diagram of an example computer device and an example mobile computer device that may be used to implement the example methods and apparatus to provide haptic feedback disclosed herein.

### DETAILED DESCRIPTION

Conventional computing devices rely on the user to visually correlate the location of a cursor and user interface elements such as windows, menu items, etc. to know when to activate a user interface element (e.g., click, select, etc.). This can make use of a user interface more difficult, for example, in low light conditions, by visually impaired persons, or when a user desires to operate a user interface without looking (e.g., discretely while the computing device is in a purse, in a pocket, beneath a table, etc.).

To overcome at least these problems, methods and apparatus that can automatically provide haptic or tactile feedback as user interface elements are navigated are disclosed herein. The examples disclosed herein can automatically provide haptic feedback as a user moves (e.g., swipes, slides, etc.) their finger(s) and/or stylus across an input device. The user's movement(s) causes a cursor to move across a display device. As the cursor moves, different user interface elements are traversed, navigated, scrolled, passed, etc. and, haptic feedback can be provided for each one. In this way, the haptic feedback provides an automatic indication to the user as each user interface element becomes traversed, thus, providing non-visual feedback by which the user interface can be navigated. Example haptic feedback output signals includes, but is not limited to, one or more, a combination, a pattern and/or a series or sequence of the same or different bumps, pulses, buzzes, taps, vibrations, etc. Different user interface elements may be associated with different haptic feedbacks, and/or a user may associate particular or custom haptic feedbacks with particular (e.g., favorite or default) user interface elements.

Reference will now be made in detail to non-limiting examples of this disclosure, examples of which are illustrated in the accompanying drawings. The examples are described below by referring to the drawings, wherein like reference numerals refer to like elements. When like reference numerals are shown, corresponding description(s) are not repeated and the interested reader is referred to the previously discussed figure(s) for a description of the like element(s). These examples and variants and portions thereof shown in the attached drawings are not drawn to scale, with specific shapes, or with specific relative dimensions as they are not important to this disclosure and may render the drawings more difficult to comprehend. Specific elements may have been intentionally exaggerated for discussion purposes. Instead, the drawings have been drawn for clarity and comprehension. Further, the arrangement of elements and couplings maybe changed, rearranged, etc. according to other implementations of this disclosure and the claims herein.

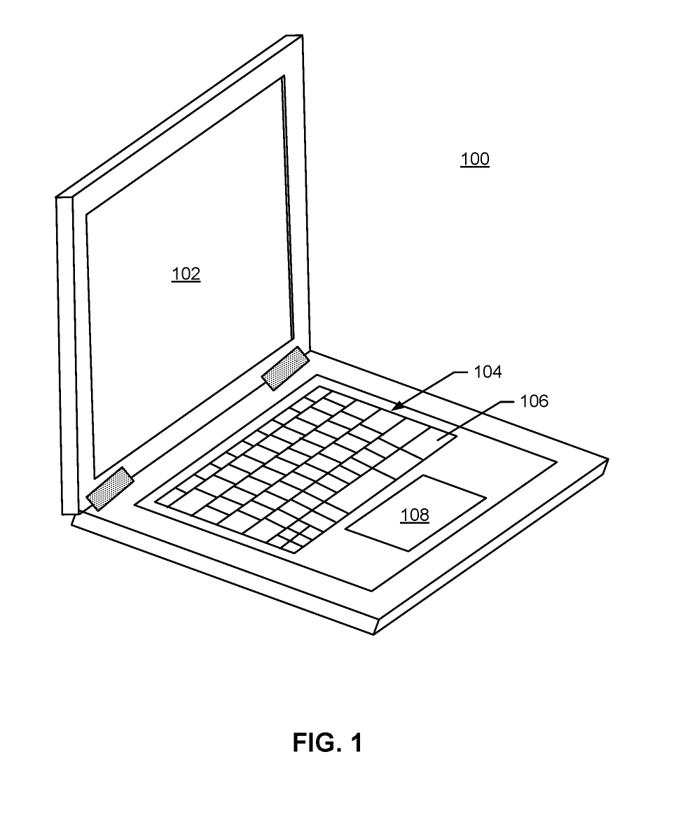

FIG. 1 shows an example computing device in the form of a laptop computer 100. The example laptop computer 100 of FIG. 1, which may be battery powered, includes a display 102, a keyboard 104 having one or more keys (one of which is designated at reference numeral 106), and a trackpad 108 through which a user can interact with the laptop computer 100. The trackpad 108 may alternatively be implemented by a touch pad. A user may use the keyboard 104 and the trackpad 108 to enter commands, instructions, text, etc. for operating the laptop computer 100 and/or applications thereon (e.g., e-mail, word processing, Internet browsing applications, etc.). The display 102 may be a touch screen that can additionally be used to control the laptop computer 100. As discussed below, the display 102 and/or the trackpad 108 may be used to provide non-visual haptic feedback as user interface elements are navigated.

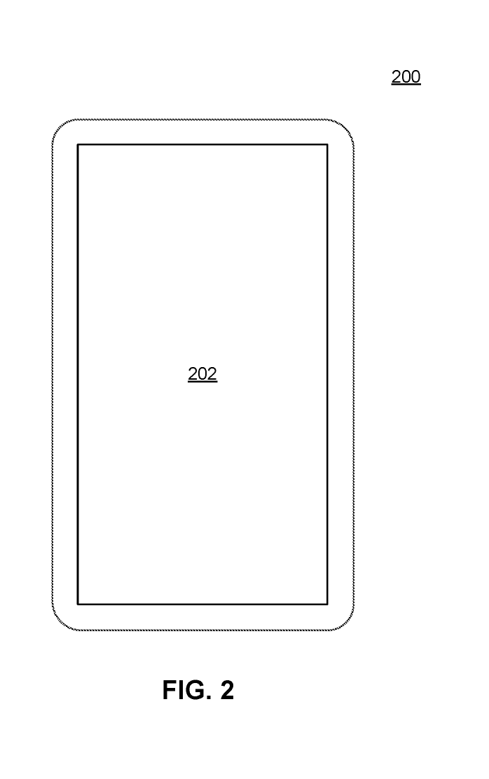

FIG. 2 shows another example mobile computing device in the form of a mobile phone 200 built on a mobile computing platform, and/or an electronic table. The example mobile phone 200 includes a touch screen 202 through which a user can interact with the mobile phone 200. As discussed below, the display 202 may be used to provide non-visual haptic feedback as user interface elements are navigated.

FIG. 3 is a schematic illustration of an example computing device 300 configured to provide haptic feedback in accordance with the teachings of this disclosure. The example computing device 300 of FIG. 3 has a touch input device 302 (e.g., a touch pad, a trackpad, etc.). To receive input(s), the touch input device 302 has any number, configuration and/or type(s) of touch cells or regions 304. The touch cells 304 provide or output data representing usage of the touch input device 302, for example, which touch cells 304 are receiving touch inputs. Touch inputs can be processed to, for example, determine how many fingers are being sensed and/or how they are pressing or moving on the touch input device 302. The example touch cells 304 may be implemented using, for example, capacitive, resistive, pressure, force, piezoelectric, etc. sensors.

To provide haptic or tactile feedback, the example touch device 302 has any number, arrangement, configuration and/or type(s) of haptic feedback devices 306, such as piezoelectric devices, oscillator or vibrator. Example haptic feedback includes haptic feedback includes, but is not limited to, one or more, a combination, a pattern and/or a series or sequence of the same or different bumps, pulses, buzzes, taps, vibrations, etc. In some instances, haptic feedback may include deformation(s) and/or vibration(s) of a surface of the touch input device 302.

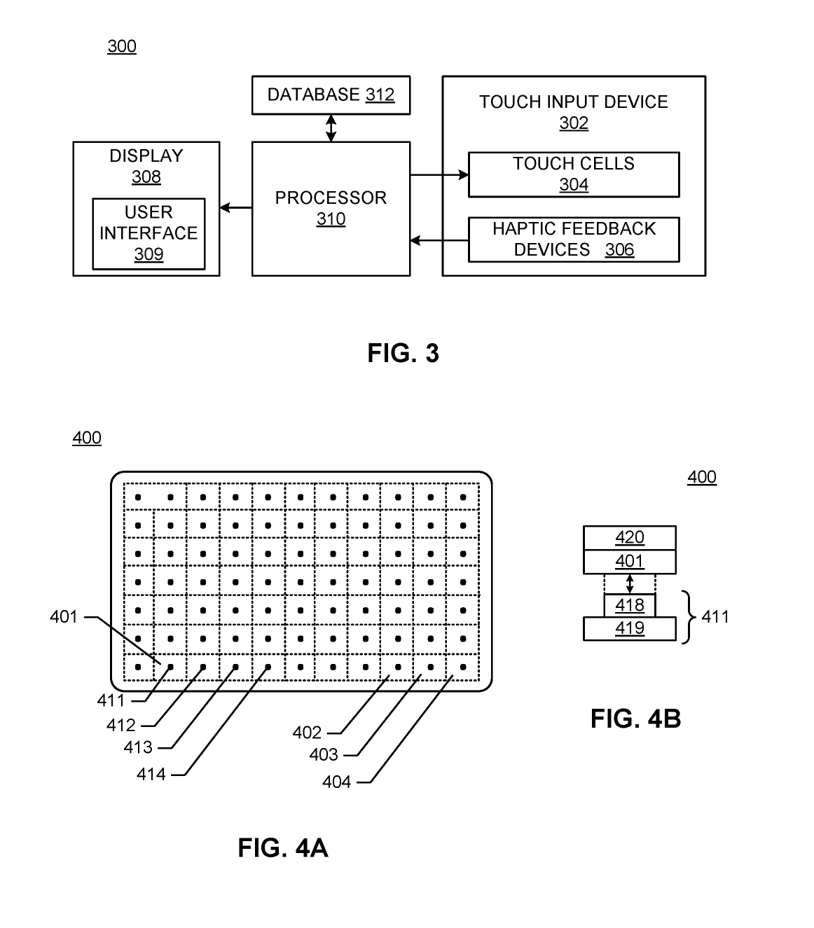

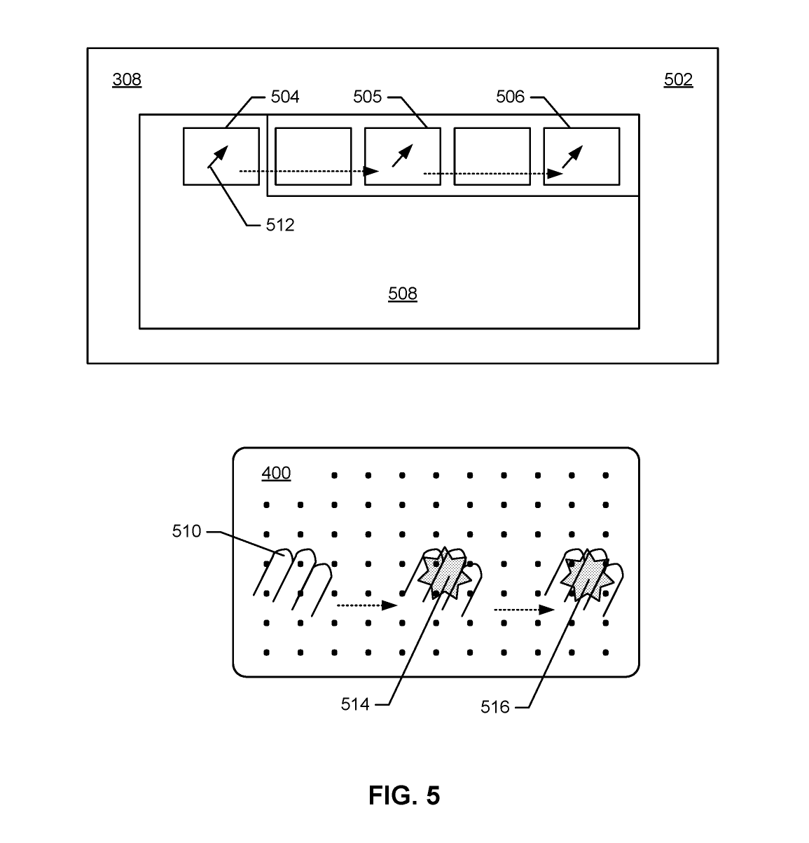

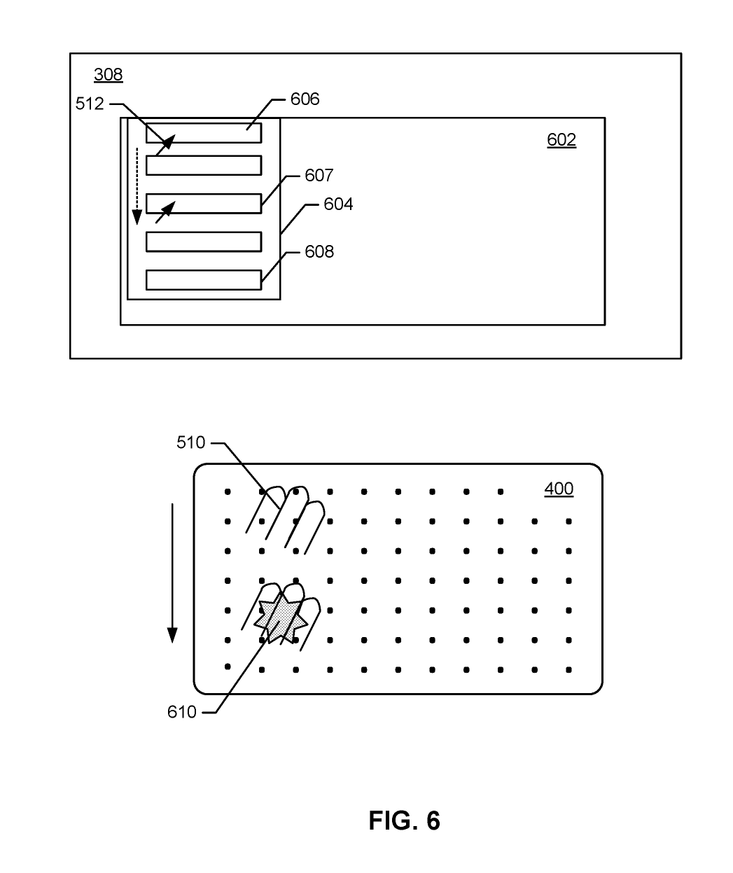

FIG. 4A is a top view of an example touch input device 400 that may be used to implement the example touch input device 302 of FIG. 3. FIG. 4B is a side view of a portion of the example touch input device 400. The example touch input device 400 includes a plurality of touch regions or cells, four of which are designated at reference numerals 401-404, which are arranged according to a grid; and a plurality of haptic feedback devices, four of which are designated at reference numerals 411-414, which are arranged according to the grid. While in the example of FIGS. 4A and 4B, there is one haptic feedback device 411-414 per touch cell 401-404, they may be provided according to a different ratio.

As shown in FIG. 4B, the touch input device 400 has a top (in the orientation of FIG. 4B) surface or fascia 420 exposed to the user, with the touch cells 401-404 arranged below the fascia 420. In some examples, the touch cells 401-404 are implemented together with (e.g., embedded in or in molded within) the fascia 420. The haptic feedback device 411 is arranged below the fascia 420, touch cell 401 combination, and is activateable to selectively extend an extendable member 418 upward from a base 419 (in the orientation of FIG. 4B) into and out of contact with the bottom of the fascia 420, touch cell 401 combination. The contact of the extendable member 418 with the fascia 420, touch cell 401 combination can be selectively controlled and used to create or form different haptic feedback output signals in the form of one or more, a combination, a pattern and/or a series or sequence of the same or different of a:
Bump, e.g., a firm or sharp single extension of the extendable member 418
Pulse, e.g., a periodic string of the extendable member 418
Buzz, e.g., a rapid sequence of the extendable member 418
Tap, e.g., a soft or gentle extension of the extendable member 418
Vibration, e.g., a rhythmic string of the extendable member 418
Ping-pong, e.g., alternating taps between two or more extendable members 418
etc.

In some examples, an extension causes a deformation of the fascia 420, touch cell 401 combination. In some examples, extensions of more than one haptic feedback device 411 are cooperatively used to provide further haptic feedbacks. For example, a vibrating ping-pong style of haptic feedback formed by alternating between two haptic feedback devices.

Returning to FIG. 3, to display user interfaces, the example computing device 300 of FIG. 3 includes a display 308 on which user interfaces, one of which is designated at reference numeral 309, may be presented. In some examples, such as the mobile phone 200 of FIG. 2, the touch device 302 and the display 308 are combined into a touch screen providing touch input, display, and haptic feedback. A user can control or operate the user interface(s) 309 to operate applications on the computing device 300 to, for example, display a web page, send/receive messages, make a phone call, playback media files, etc.

To control the computing device 300, the example computing device 300 of FIG. 3 includes any type of processor 310. The processor 310 is programmed to, in some examples, display on the display 308 the user interface(s) 309 to enable a user to operate applications on the computing device 300.

The processor 310 can process outputs of the touch cells 304 to determine which touch cells 304 are receiving touch inputs. Touch inputs can be processed by the processor 310 to, for example, determine how many fingers are being sensed and/or how and where they are pressing or moving on the touch input device 302. As the touch cell outputs are processed, the processor 310 can, as is conventional, correspondingly move a cursor on the display 308 for the various user interfaces 309.

As it moves from user interface element to user interface elements (e.g., between a collection of items such as photographs), the processor 310 controls the haptic (e.g., tactile) feedback devices 306 to provide non-visual haptic (e.g., tactile) feedback regarding the transition between items. For example, if the touch inputs represent movement through, for example, a collection of items, a haptic feedback can be provided as each item is passed. For example, if the user moves their finger(s) left to right through the collection without lifting their finger(s), a cursor sequentially reaches each item in a left to right fashion. As each menu item is reached, a haptic feedback is provided at the current location of the finger(s). Accordingly, the location of the haptic feedbacks moves left to right as the items are progressively traversed. Thus, the haptic feedbacks can indicate items being passed as well as indicate where in the collection of items is currently being navigated. In some examples, every item is indicated by the same haptic feedback output signal, as follows
Item 1—tap
Item 2—tap
. . .
Last item—tap

In some examples, every item is indicated by the same haptic feedback output signal except for the last item, which is differently indicated to identify that the end of the collection has been reached, as follows
Item 1—tap
Item 2—tap
. . .
Last item—bump

In some examples, every item is indicated by the same haptic feedback output signal except for an item a user has flagged as a favorite, which is differently indicated to let the user know their favorite has been located, as follows
Item 1—tap
Item 2—tap
. . .
Favorite Item—vibrate
. . .
Last item—bump

An item may be designated as a favorite and assigned a haptic feedback output signal using any number and/or type(s) of methods, interfaces and/or dialog boxes. A haptic feedback output signal for a favorite can serve a purpose similar to a ringtone. An example favorite haptic feedback output signal is a customized series of bumps. Different haptic feedbacks may be used to signify other types of items such as, but not limited to, default items (e.g., in a menu), disabled items (e.g., in a menu).

The use of different haptic feedbacks can, thus, be used to not just indicate the traversing of or to an item, but to indicate additional information regarding the item. For example, if a user wishes to navigate a menu to the default menu item, they can navigate through the menu until, for example, a pulse is felt. Because they can feel the difference between the default tap and a pulse, they can navigate to and select the default menu item without having to visually navigate the menu as well.

The processor 310 may, in some instances, query a database 312 to identify or determine the form of haptic feedback associated with particular user interface elements and/or transitions. In some examples, the haptic feedback provided depends on operating system defaults, application developer settings, user settings, and/or user customizations. User customizations can be used to, for example, define notification haptic feedbacks for messages or phone calls (e.g., haptic ring tones) that are different for different persons.

Turning to FIGS. 5-7, various haptic feedback examples are shown. While examples are shown in FIGS. 5-7, it will be understood that there are other ways of using the teachings of this disclosure to provide haptic feedback. Moreover, the examples shown may be combined in various ways. Further, while example user interface elements are shown and discussed herein, the haptic feedback examples disclosed herein may be used with other user interface elements.

In the example of FIG. 5, the display 308 presents a user interface 502 having a plurality of user interface elements, three of which are designated at reference numerals 504-506. The example elements 504-506 of FIG. 5 represent web browser tabs of a web browser 508. As shown, as three fingers 510 move across the touch device 400, a cursor 512 moves corresponding across the tabs 504-506 of the web browser 508. When the movement of the fingers 510 causes the cursor 512 to become positioned on the tab 505, haptic feedback 514 is provided to the user, thus, providing a non-visual indication that the cursor 512 is on the tab 505 even when the user is not viewing the display 308. Haptic feedback can be similarly provided for others of the tabs 504-506. In some examples, the last tab 506 has different haptic feedback 516 (e.g., a bump) to non-visually indicate that it is the last of the tabs. In some examples, favorite, default and/or disabled tabs may be indicated with a different haptic feedback than other tabs. In at least these ways, a user can navigate the user interface 520 using, at least in part, non-visual haptic indications.

Turning to FIG. 6, the display 308 presents an application 602 having a menu 604 with a plurality of user interface elements in the form of menu items, three of which are designated at reference numerals 606-608. As shown, as the fingers 510 move down the touch device 400, the cursor 512 moves corresponding down the menu items 606-608. When the movement of the fingers 510 causes the cursor 512 to become positioned on the menu item 607, haptic feedback 610 is provided to the user, thus, providing a non-visual indication that the cursor 512 is on the menu item 607 even when the user is not viewing the display 308. Haptic feedback can be similarly provided for others of the menu items 606-608. In some examples, the last menu item 608 has different haptic feedback (e.g., a bump) to indicate that it is the last of the menu items. In some examples, favorite, default and/or disabled menu items may be indicated with a different haptic feedback than other menu items. In at least these ways, a user can navigate the menu 604 using, at least in part, non-visual haptic indications.

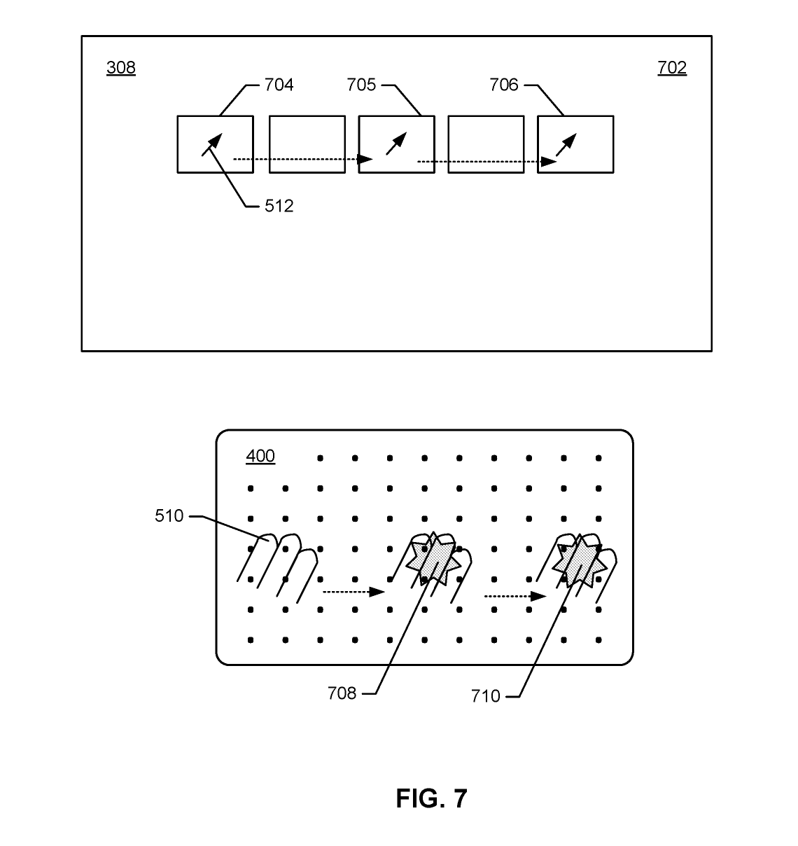

Moving to FIG. 7, the display 308 presents a user interface 702 having a plurality of user interface elements, three of which are designated at reference numerals 704-706, arranged in a row. The example elements 704-706 of FIG. 7 represent any collection or list of windows, files (e.g., audio, video, image, etc.), applications, selections, information, etc., and may be arranged in other ways (e.g., vertically, diagonally, rectilinearly, circularly, etc.). The elements 704-706 may also be used to represent a scrollable list of items. As shown, as the fingers 510 move across the touch device 400, the cursor 512 moves corresponding across the elements 704-706. When the movement of the fingers 510 causes the cursor 512 to become positioned on the element 705, haptic feedback 708 is provided to the user, thus, providing a non-visual indication that the cursor 512 is on the element 705 even when the user is not viewing the display 308. Haptic feedback can be similarly provided for others of the elements 704-706. In some examples, the last element 706 has different haptic feedback 710 (e.g., a bump) to indicate that it is the last of the tabs. In some examples, favorite, default and/or disabled elements may be indicated with a different haptic feedback than other elements. The example of FIG. 7 may be used to, for example, provide haptic feedback as a user browses or moves between files. For example, a user can swipe to move between their music files with haptic feedback provided as the files pass. Feedback may be provided for each file, for each 10 files, etc. A different feedback maybe provided when the last file is reached. In at least these ways, a user can navigate the user interface 702 using, at least in part, non-visual haptic indications.

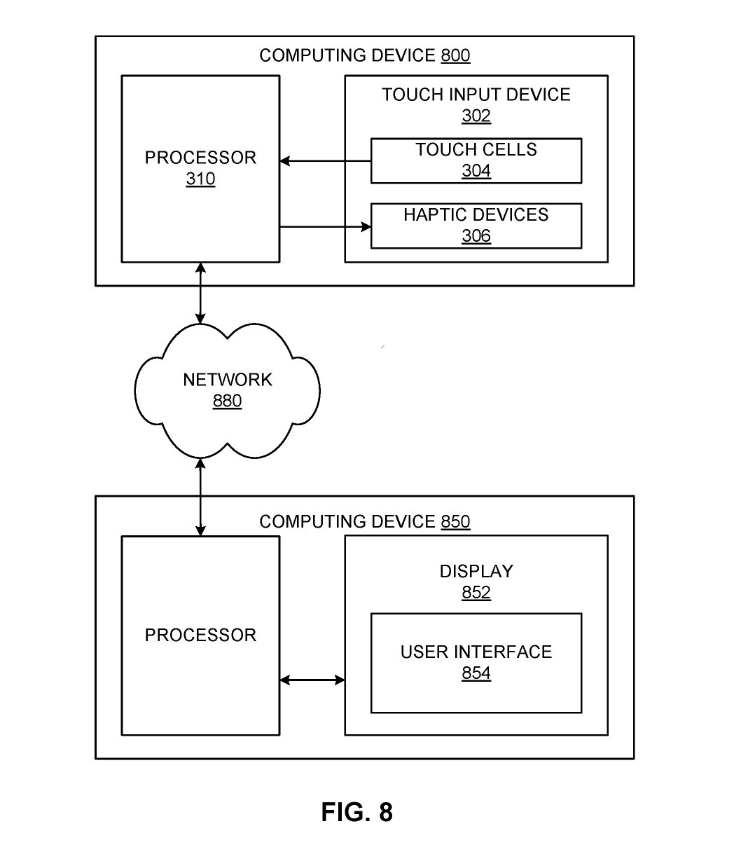

FIG. 8 is a schematic illustration of another example computing device 800 configured to provide haptic feedback in accordance with the teachings of this disclosure. The description of like reference numerals in FIGS. 3, 4A, 4B and 8 is not repeated here, instead the interested reader is referred to the previously discussed figure(s) for a description of the like element(s).

In comparison to FIG. 3, the computing device 800 implements a touch input device 302 for another computing device 850, which implements a display 852 and user interface 854. In the arrangement of FIG. 8, the computing device 800 implements a remote controller for the computing device 850 via any number and/or type(s) of communicatively couplings via, for example, a network 880. The example of FIG. 8 can be operated to provide haptic feedback similarly to at least the examples of FIGS. 3, 4A, 4B and 5-7, where the user interface is displayed remotely on the computing device 850 rather than locally on the computing device 800. Such arrangement can be useful when the computing device 800 is a remote control device for another computing device such as a set-top box, a media streaming box, a computer, a game controller, etc.

In addition to, or instead of providing haptic feedback as user interfaces are navigated, haptic feedback may be provided to alert a user to notifications. Using non-visual haptic feedback, a user can be alerted to and take action regarding a notification without having to view or listen to a conventional alert notification. Each notification alert could be assigned its own haptic feedback pattern that can be used to identify for a user the type of notification. A user can interact with the haptic alert by pressing and holding the location of the notification alert to open the alert, or ignore the alert and continue with their use of the computing device. Example notification alerts include, but are not limited to, end of document reached, end of web page reached, snap-to (e.g., buzz or series of bumps when a webpage is about to snap to ½ of screen), moving between two apps executing in ½ screen side-by-side mode, new electronic message (e.g., email), new text message, new voice call, new voice message, error, etc. In some examples, the level of haptic feedback increases depending on whether accessibility is enabled on a device. For example, when accessibility is enabled more haptic feedback is provided.

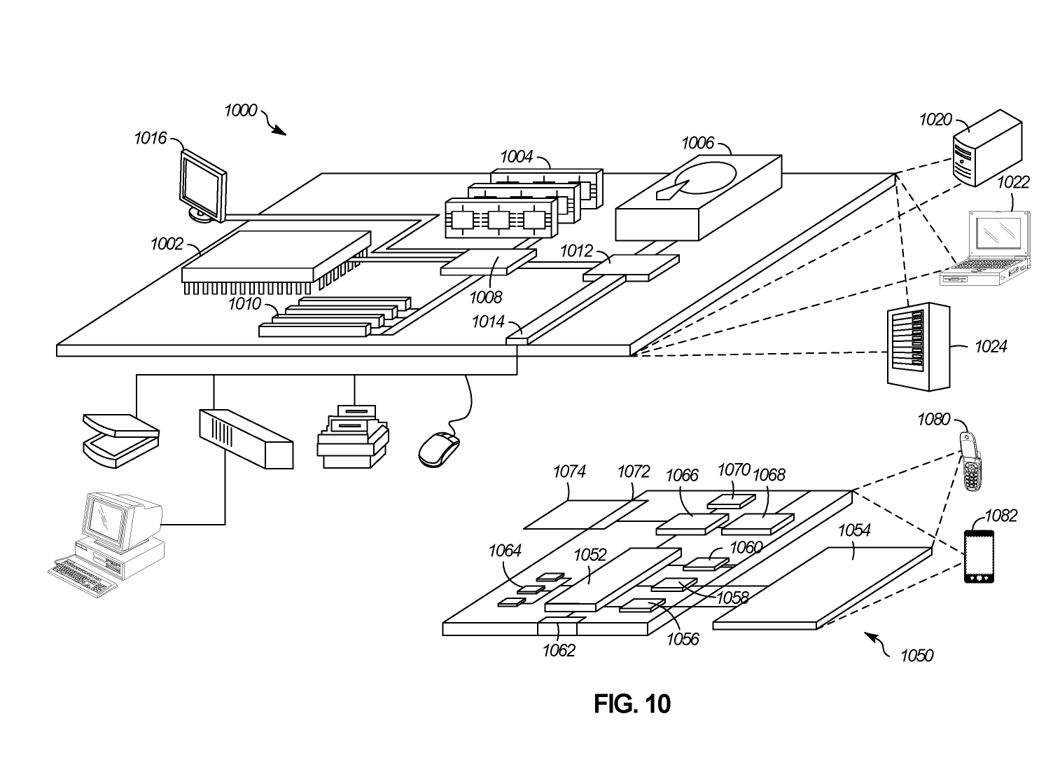

One or more of the elements and interfaces shown herein may be combined, divided, re-arranged, omitted, eliminated and/or implemented in any other way. Further, one or more circuit(s), programmable processor(s), fuses, application-specific integrated circuit(s) (ASIC(s)), programmable logic device(s) (PLD(s)), field-programmable logic device(s) (FPLD(s)), and/or field-programmable gate array(s) (FPGA(s)), etc. can be used. Moreover, more interfaces and/or elements may be included instead of, or in addition to, those shown, and/or may include more than one of any or all of the illustrated interfaces and elements. The elements shown may, for example, be implemented as machine-readable instructions carried out by one or more processors. A processor, a controller and/or any other suitable processing device such as those shown in FIG. 10 may be used, configured and/or programmed to execute and/or carry out the examples disclosed herein. For example, the disclosed examples may be embodied in program code and/or machine-readable instructions stored on a tangible and/or non-transitory computer-readable medium accessible by a processor, a computer and/or other machine having a processor, such as that discussed below in connection with FIG. 10. Machine-readable instructions comprise, for example, instructions that cause a processor, a computer and/or a machine having a processor to perform one or more particular processes. Many other methods of implementing the disclosed examples may be employed. For example, the order of execution may be changed, and/or one or more of the blocks and/or interactions described may be changed, eliminated, sub-divided, or combined. Additionally, any or the entire example may be carried out sequentially and/or carried out in parallel by, for example, separate processing threads, processors, devices, discrete logic, circuits, etc.

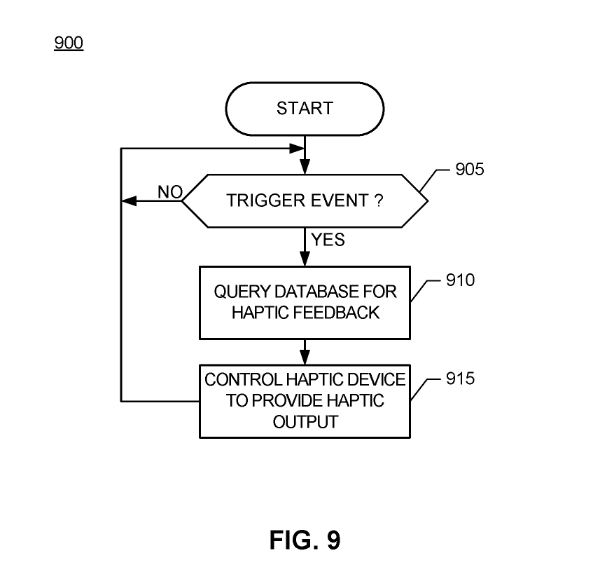

Turning to FIG. 9, an example method 900 that may be performed to provide haptic feedback as disclosed herein is shown. The example method 900 of FIG. 9 begins with a processor (e.g., the processor 310) determining whether a trigger event has occurred (block 905). Example trigger events include, but are not limited to, the navigation of a cursor to a new user interface element, a new file, a new list item, a new window, a new application, a new alert notification, etc.

When a trigger event has occurred (block 905), the processor identifies the haptic feedback for the event by, for example, querying a database 312 (block 910) and controlling the haptic feedback devices 306 to provide the haptic feedback (block 915). Control returns to block 905 to wait for another trigger event (block 905).

The example method 900 of FIG. 9, or other methods disclosed herein, may, for example, be implemented as machine-readable instructions carried out by one or more processors to control or operate the example display assemblies disclosed herein. A processor, a controller and/or any other suitable processing device may be used, configured and/or programmed to execute and/or carry out the example methods disclosed herein. For instance, the example method 900 of FIG. 9, or other methods disclosed herein may be embodied in program code and/or machine-readable instructions stored on a tangible and/or non-transitory computer-readable medium accessible by a processor, a computer and/or other machine having a processor, such as that discussed below in connection with FIG. 10. Machine-readable instructions comprise, for example, instructions that cause a processor, a computer and/or a machine having a processor to perform one or more particular processes. Many other methods of implementing the example method 900 of FIG. 9, or other methods disclosed herein may be employed. For example, the order of execution may be changed, and/or one or more of the blocks and/or interactions described may be changed, eliminated, sub-divided, or combined. Additionally, any of the entire example method 900 of FIG. 9, or other methods disclosed herein may be carried out sequentially and/or carried out in parallel by, for example, separate processing threads, processors, devices, discrete logic, circuits, etc.

As used herein, the term “computer-readable medium” is expressly defined to include any type of tangible or non-transitory computer-readable medium and to expressly exclude propagating signals. Example computer-readable medium include, but are not limited to, a volatile and/or non-volatile memory, a volatile and/or non-volatile memory device, a compact disc (CD), a digital versatile disc (DVD), a read-only memory (ROM), a random-access memory (RAM), a programmable ROM (PROM), an electronically-programmable ROM (EPROM), an electronically-erasable PROM (EEPROM), an optical storage disk, an optical storage device, a magnetic storage disk, a magnetic storage device, a cache, and/or any other storage media in which information is stored for any duration (e.g., for extended time periods, permanently, brief instances, for temporarily buffering, and/or for caching of the information) and that can be accessed by a processor, a computer and/or other machine having a processor.

Turning to FIG. 10, an example of a generic computing device 1000 and a generic mobile computing device 1050, which may be used with the techniques described here. Computing device 1000 is intended to represent various forms of digital computers, such as laptops, desktops, tablets, workstations, personal digital assistants, televisions, servers, blade servers, mainframes, and other appropriate computing devices. Computing device 1050 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1000 includes a processor 1002, memory 1004, a storage device 1006, a high-speed interface 1008 connecting to memory 1004 and high-speed expansion ports 1010, and a low speed interface 1012 connecting to low speed bus 1014 and storage device 1006. The processor 1002 can be a semiconductor-based processor. The memory 1004 can be a semiconductor-based memory. Each of the components 1002, 1004, 1006, 1008, 1010, and 1012, are interconnected using various busses, connections, memories, caches, etc. and may be mounted on a common motherboard or in other manners as appropriate. The processor 1002 can process instructions for execution within the computing device 1000, including instructions stored in the memory 1004 or on the storage device 1006 to light-emitting portion graphical information for a GUI on an external input/output device, such as light-emitting portion 1016 coupled to high speed interface 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, or memory on processor 1002.

The high speed controller 1008 manages bandwidth-intensive operations for the computing device 1000, while the low speed controller 1012 manages lower bandwidth-intensive operations. Such allocation of functions is exemplary only. In one implementation, the high-speed controller 1008 is coupled to memory 1004, light-emitting portion 1016 (e.g., through a graphics processor or accelerator), and to high-speed expansion ports 1010, which may accept various expansion cards (not shown). In the implementation, low-speed controller 1012 is coupled to storage device 1006 and low-speed expansion port 1014. The low-speed expansion port, which may include various communication ports (e.g., USB, Bluetooth, Ethernet, Wi-Fi) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a light-emitting portion 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a user through control interface 1058 and light-emitting portion interface 1056 coupled to a light-emitting portion 1054. The light-emitting portion 1054 may be, for example, a TFT LCD (Thin-Film-Transistor Liquid Crystal Light-emitting portion) or an OLED (Organic Light-emitting Diode) light-emitting portion, or other appropriate light-emitting portion technology. The light-emitting portion interface 1056 may comprise appropriate circuitry for driving the light-emitting portion 1054 to present graphical and other information to a user. The control interface 1058 may receive commands from a user and convert them for submission to the processor 1052. In addition, an external interface 1062 may be provided in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a SIMM (Single Inline Memory Module) card interface. Such expansion memory 1074 may provide extra storage space for device 1050, or may also store applications or other information for device 1050. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer or machine-readable medium, such as the memory 1064, expansion memory 1074, or memory on processor 105 that may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, Wi-Fi, or other such transceiver (not shown). In addition, GPS (Global Positioning System) receiver module 1070 may provide additional navigation- and location-related wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smart phone 1082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a light-emitting portion device (e.g., a CRT (cathode ray tube) or LCD (liquid crystal light-emitting portion) monitor) for light-emitting portioning information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Connecting lines and connectors shown in the various figures presented are intended to represent exemplary functional relationships and/or physical or logical couplings between the various elements. It should be noted that many alternative and/or additional functional relationships, physical connections or logical connections may be present. Moreover, no item or component is essential to the practice of this disclosure unless the element is specifically described as “essential” or “critical”. Additionally, the figures and/or drawings are not drawn to scale, but rather are drawn for clarity of illustration and description.

Although certain example methods, apparatuses and articles of manufacture have been described herein, the scope of coverage of this patent is not limited thereto. It is to be understood that terminology employed herein is for the purpose of describing particular aspects, and is not intended to be limiting. On the contrary, this patent covers all methods, apparatus and articles of manufacture fairly falling within the scope of the claims of this patent.

What is claimed is:

1. A method comprising:
presenting a menu having a plurality of menu items;
receiving data representative of navigation of the menu items using a touch input device;
processing the data to determine when menu items is navigated; and
as the menu items are navigated, providing haptic feedbacks via the touch input device.

2. The method of claim 1, wherein the providing the haptic feedbacks comprises providing a first haptic feedback output signal as a first menu item is navigated.

3. The method of claim 2, wherein the first haptic feedback output signal is provided at a location corresponding to the first menu item.

4. The method of claim 2, further comprising receiving a user input defining the first haptic feedback output signal.

5. The method of claim 2, wherein the first haptic feedback output signal represents a favorite menu item, a default menu item, or a last menu item.

6. The method of claim 1, wherein the providing the haptic feedbacks comprises:
providing a first haptic feedback output signal as a first menu item is navigated; and
providing a second different haptic feedback output signal as a second menu item is navigated.

7. The method of claim 6, further comprising not providing a haptic feedback output signal as a third menu item is navigated.

8. The method of claim 6, wherein the second haptic feedback output signal differs from the first haptic feedback output signal to designate at least one of a last menu item, a default menu item, or a favorite menu item.

9. The method of claim 1, wherein the menu is presented on a first computing device, and the respective haptic feedbacks are provided on a second computing device distinct from the first computing device.

10. The method of claim 1, wherein the haptic feedbacks comprises at least one of a bump, a tap, a buzz, a vibration, and/or a pulse.

11. A computing device comprising:
an output device to present a plurality of items;
a touch input device configured to enable a person to scroll through the plurality of items;
a tactile feedback device associated with the touch input device; and
a processor programmed to, sense scrolling of the plurality of items via the touch input device, and as the items are scrolled by, providing tactile feedbacks via the tactile feedback device.

12. The computing device of claim 11, wherein the processor provides the tactile feedbacks by:
providing a first tactile feedback output signal as a first item is scrolled by; and
providing a second different tactile feedback output signal as a second item is scrolled by.

13. The computing device of claim 12, further comprising not providing a tactile feedback output signal as a third item is scrolled by.

14. The computing device of claim 12, wherein the first tactile feedback output signal is provided at a location on the touch input device corresponding to the first item.

15. The computing device of claim 11, wherein the tactile feedbacks comprise at least one of a bump, a tap, a buzz, a vibration, and/or a pulse.

16. The computing device of claim 11, wherein the items represent at least one of a menu item, a user interface window, an application window, a web browser tab, a picture, a video, and/or a song.

17. The computing device of claim 11, wherein the tactile feedback device comprises a piezoelectric device.

18. A tangible non-transitory article of manufacture storing machine-readable instructions that, when executed, cause a machine to at least:
present a menu having a plurality of menu items;
receive a signal representative of traversal through the menu items using a touch input device;
process the signal to determine when menu items are traversed; and
as the menu items are traversed, provide haptic feedbacks via the touch input device.

19. The tangible non-transitory article of manufacture of claim 18, wherein the user interface element is presented on a second machine.

20. The tangible non-transitory article of manufacture of claim 18, wherein the machine-readable instructions, when executed, cause the machine to provide the haptic feedbacks by:
providing a first haptic feedback output signal as a first menu item is navigated; and
providing a second different haptic feedback output signal as a second menu item is navigated.
